(19) United States
(12) Patent Application Publication
(10) Pub. No.: US 2026/0264867 A1
(43) Pub. Date: Sep. 10, 2026

(54) ENGINE CONTROL DEVICE, FLYING OBJECT, ENGINE CONTROL METHOD, AND STORAGE MEDIUM

(71) Applicant: HONDA MOTOR CO., LTD., Tokyo (JP)

(72) Inventor: Hisao Haga, Wako-shi (JP)

(21) Appl. No.: 19/553,765

(22) Filed: Mar. 2, 2026

(30) Foreign Application Priority Data
Mar. 4, 2025 (JP) 2025-033418

(51) Int. Cl. B64D 31/18; B64D 31/06

(52) U.S. Cl. CPC B64D 31/18; B64D 31/06

(57) ABSTRACT

An engine control device includes: a standby information acquisition unit that acquires standby information indicating whether or not a flying object is on standby on the ground; a required electric power acquisition unit that acquires required electric power of an electric device; and a control unit that controls an engine. Even in the case where the standby information indicates that the flying object is on standby on the ground, the control unit controls output power of the engine based on the required electric power acquired by the required electric power acquisition unit, and in the case where the standby information indicates that the flying object is on standby on the ground, the control unit fixes an engine rotational speed at a rotational speed determined in advance.

### CROSS-REFERENCE TO RELATED APPLICATIONS

This application is based upon and claims the benefit of priority from Japanese Patent Application No. 2025-033418 filed on March 4, 2025, the contents of which are incorporated herein by reference.

### BACKGROUND OF THE INVENTION

### Field of the Invention

The present disclosure relates to an engine control device, a flying object, an engine control method, and a storage medium.

### Description of the Related Art

JP 6557321 B2 discloses an assistance device for a free-turbine engine of an aircraft.

### SUMMARY OF THE INVENTION

There has been a demand for a more satisfactory engine control device and the like.

The present disclosure has the object of solving the above-described problem.

A first aspect of the present disclosure is characterized by an engine control device for a flying object, the flying object including an engine, a generator configured to be driven by the engine and generate electric power, a power storage device configured to store electric power, and an electric device configured to operate using the electric power generated by the generator or the electric power stored in the power storage device, the engine control device comprising: a standby information acquisition unit configured to acquire standby information indicating whether or not the flying object is on standby on a ground; a required electric power acquisition unit configured to acquire required electric power of the electric device; and a control unit configured to control the engine, wherein the control unit controls output power of the engine based on the required electric power acquired by the required electric power acquisition unit, and in a case where the standby information indicates that the flying object is on standby on the ground, the control unit fixes an engine rotational speed that is a rotational speed of the engine, at a rotational speed determined in advance.

A second aspect of the present disclosure is characterized by a flying object comprising the engine control device according to the first aspect.

A third aspect of the present disclosure is characterized by an engine control method for a flying object, the flying object including an engine, a generator configured to be driven by the engine and generate electric power, a power storage device configured to store electric power, and an electric device configured to operate using the electric power generated by the generator or the electric power stored in the power storage device, the engine control method comprising: causing a standby information acquisition unit to acquire standby information indicating whether or not the flying object is on standby on a ground; causing a required electric power acquisition unit to acquire required electric power of the electric device; and causing a control unit to control the engine, wherein the control unit controls output power of the engine based on the required electric power acquired by the required electric power acquisition unit, and in a case where the standby information indicates that the flying object is on standby on the ground, the control unit fixes an engine rotational speed that is a rotational speed of the engine, at a rotational speed determined in advance.

A fourth aspect of the present disclosure is characterized by a program for causing a computer to execute the engine control method according to the third aspect.

A fifth aspect of the present disclosure is characterized by a non-transitory computer-readable storage medium configured to store the program according to the fourth aspect.

According to the present disclosure, a more satisfactory engine control device and the like can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a flying object according to an embodiment of the present disclosure;

FIG. 2 is a schematic diagram showing a configuration of a power supply system according to the embodiment;

FIG. 3 is a block diagram showing a control system according to the embodiment;

FIG. 4 is a block diagram showing a configuration of a management control device and a configuration of an engine control device according to the embodiment;

FIG. 5 is a flowchart of idling control executed by the engine control device according to the embodiment; and

FIG. 6 is a graph showing a relationship between an engine rotational speed and output power on a surge line, a stall line, and an efficient operation line of an engine according to the embodiment.

### DETAILED DESCRIPTION OF THE INVENTION

A flying object such as an electric vertical take-off and landing aircraft (eVTOL aircraft) obtains thrust by driving rotors with electric motors. Such a flying object includes, as power sources, a power generation device including a generator driven by an engine, and a power storage device including a battery.

The flying object includes an auxiliary device in addition to the electric motors that drive the rotors and the like. The auxiliary device is, for example, a fuel pump for the engine, an oil pump for the generator, a cooling water pump for the battery, a cooling water pump for the electric motor, or the like.

In the case where the flying object is on standby on the ground, the electric motors that drive the rotors are stopped. However, the auxiliary device is being driven even during standby on the ground, and it is necessary to supply electric power to the auxiliary device. Conventionally, in the case where the flying object is on standby on the ground, the generator does not generate electric power, and the engine maintains a rotational speed (idling rotational speed) at which the engine can rotate in a self-sustaining manner in a substantially no-load state. Therefore, the electric power of the battery is supplied to the auxiliary device during standby on the ground. For this reason, there has been a problem that the state of charge (SOC) of the battery decreases during standby on the ground.

Further, the engine is more likely to stall as the engine rotational speed decreases. In order to suppress the stall of the engine, it is conceivable to cause the generator to perform power running by the electric power of the battery and assist the rotation of the engine by the generator. However, in this case, there is a problem that the SOC of the battery further decreases during standby on the ground.

The engine control device of the present disclosure can suppress a decrease in the SOC of the battery while suppressing the stall of the engine during standby on the ground.

### Embodiments

### Configuration of Flying Object

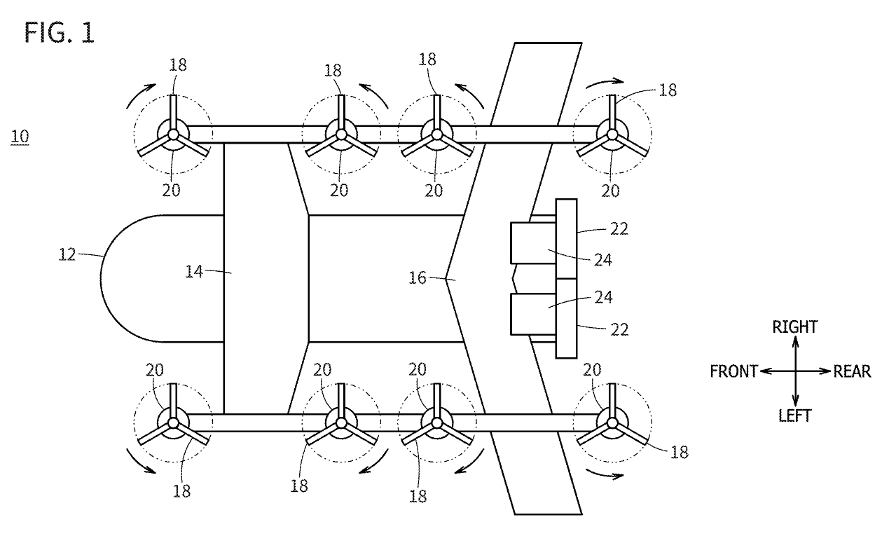

FIG. 1 is a schematic diagram of a flying object 10 according to an embodiment of the present disclosure. The flying object 10 of the embodiment is, for example, an eVTOL aircraft. The flying object 10 includes a fuselage 12. The fuselage 12 is provided with a cockpit, a cabin, and the like. A pilot rides in the cockpit and controls the flying object 10. Passengers and the like ride in the cabin. The flying object 10 may be automatically controlled.

The flying object 10 includes a front wing 14 and a rear wing 16. In the case where the flying object 10 moves forward, lift is generated in each of the front wing 14 and the rear wing 16.

The flying object 10 includes eight VTOL rotors 18 and two cruise rotors 22. One VTOL electric motor 20 is provided for one VTOL rotor 18. The VTOL electric motor 20 is a single three-phase motor. One cruise electric motor 24 is provided for one cruise rotor 22. The cruise electric motor 24 is a dual three-phase motor.

### Configuration of Power Supply System

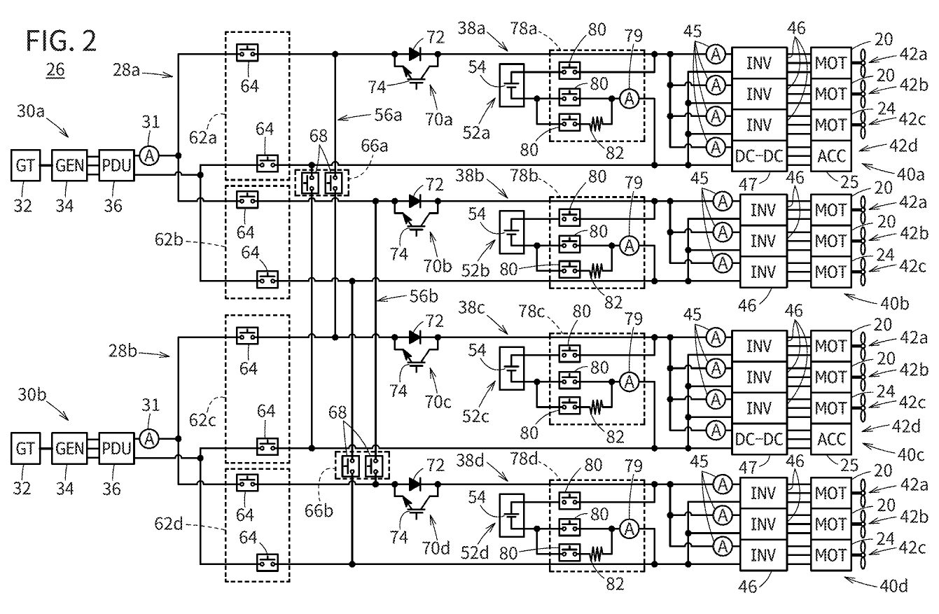

FIG. 2 is a schematic diagram showing a configuration of a power supply system 26 according to the embodiment. The power supply system 26 includes two power supply subsystems, that is, a first power supply subsystem 28a and a second power supply subsystem 28b. The power supply system 26 includes two power generation devices 30 as main power sources. The two power generation devices 30 are a power generation device 30a and a power generation device 30b. The power generation device 30a is provided in the first power supply subsystem 28a, and the power generation device 30b is provided in the second power supply subsystem 28b.

Each of the power generation devices 30 includes an engine 32, a generator 34, and a power drive unit (hereinafter referred to as a PDU) 36. The engine 32 is a gas turbine engine. The engine 32 may be a reciprocating engine instead of the gas turbine engine. The generator 34 is a motor generator. The engine 32 drives the generator 34. As a result, the generator 34 generates electric power. The PDU 36 is an inverter including a switching element. By controlling the switching element, the PDU 36 converts the AC power generated by the generator 34 into DC power and outputs the DC power.

In the case where the engine 32 is started, by controlling the switching element, the PDU 36 converts the DC power input to the PDU 36 into three-phase AC power and outputs the three-phase AC power to the generator 34. The three-phase AC power causes the generator 34 to operate, and the generator 34 starts the engine 32.

The power generation devices 30 each include a current sensor 31. The current sensor 31 detects the current of electric power input to and output from each power generation device 30. The current sensor 31 is provided on the positive wire, but may be provided on the negative wire.

The power generation devices 30 may each include various sensors such as a voltage sensor, and elements such as a fuse, a relay, a breaker, a diode, a transistor, a resistor, a coil, and a capacitor.

The power supply system 26 includes four power supply circuits 38. The four power supply circuits 38 are a power supply circuit 38a, a power supply circuit 38b, a power supply circuit 38c, and a power supply circuit 38d.

The power supply system 26 includes four load modules 40. The four load modules 40 are a load module 40a, a load module 40b, a load module 40c, and a load module 40d.

The power supply circuit 38a supplies, to the load module 40a, the DC power supplied from the power generation device 30a. The power supply circuit 38b supplies, to the load module 40b, the DC power supplied from the power generation device 30a. The power supply circuit 38c supplies, to the load module 40c, the DC power supplied from the power generation device 30b. The power supply circuit 38d supplies, to the load module 40d, the DC power supplied from the power generation device 30b.

Each of the load module 40a and the load module 40c includes four load devices 42. The four load devices 42 are a load device 42a, a load device 42b, a load device 42c, and a load device 42d. Each of the load module 40b and the load module 40d includes three load devices 42. The three load devices 42 are the load device 42a, the load device 42b, and the load device 42c.

The load device 42a and the load device 42b each include a drive device 46 and the VTOL electric motor 20. The load device 42c includes the drive device 46 and the cruise electric motor 24. The drive device 46 is an inverter including a switching element. By controlling the switching element, the drive device 46 converts the DC power input to the drive device 46 into three-phase AC power, and outputs the three-phase AC power to the VTOL electric motor 20 or the cruise electric motor 24.

The load device 42d includes a voltage conversion device 47 and an auxiliary device 25. The voltage conversion device 47 is a DC-DC converter. The voltage conversion device 47 steps down the voltage input to the voltage conversion device 47 and outputs the stepped-down voltage to the auxiliary device 25. The auxiliary device 25 is, for example, a fuel pump for the engine 32, an oil pump for the generator 34, a cooling water pump for a battery 54 described later, a cooling water pump for the VTOL electric motor 20, a cooling water pump for the cruise electric motor 24, or the like. The auxiliary device 25 corresponds to an electric device of the present invention.

It should be noted that the cruise electric motor 24 of the load device 42c of the load module 40a and the cruise electric motor 24 of the load device 42c of the load module 40c are the same electric motor. Further, the cruise electric motor 24 of the load device 42c of the load module 40b and the cruise electric motor 24 of the load device 42c of the load module 40d are the same electric motor. As described above, the cruise electric motor 24 is a dual three-phase motor and is driven by two drive devices 46.

The load devices 42 each include a current sensor 45. The current sensor 45 detects the current of electric power input to and output from each load device 42. The current sensor 45 is provided on the positive wire, but may be provided on the negative wire.

The load devices 42 may each include various sensors such as a voltage sensor, and elements such as a fuse, a relay, a breaker, a diode, a transistor, a resistor, a coil, and a capacitor.

The power supply system 26 includes four power storage devices 52. The four power storage devices 52 are a power storage device 52a, a power storage device 52b, a power storage device 52c, and a power storage device 52d. The power storage device 52 is connected to each power supply circuit 38. The power storage device 52 is connected in parallel with the power generation device 30. The power storage devices 52 each include a battery 54. The battery 54 is, for example, a lithium ion battery.

The power storage devices 52 may each include various sensors such as a voltage sensor, and elements such as a fuse, a relay, a breaker, a diode, a transistor, a resistor, a coil, and a capacitor.

The power supply circuit 38a and the power supply circuit 38c can be connected by a connection circuit 56a. The power supply circuit 38b and the power supply circuit 38d can be connected by a connection circuit 56b.

The power supply system 26 includes four first disconnection devices 62. The four first disconnection devices 62 are a first disconnection device 62a, a first disconnection device 62b, a first disconnection device 62c, and a first disconnection device 62d. The first disconnection devices 62 each include two contactors 64. One contactor 64 is provided on the positive wire, and another contactor 64 is provided on the negative wire.

The first disconnection device 62a can disconnect the power generation device 30a from the power supply circuit 38a. The first disconnection device 62b can disconnect the power generation device 30a from the power supply circuit 38b. The first disconnection device 62c can disconnect the power generation device 30b from the power supply circuit 38c. The first disconnection device 62d can disconnect the power generation device 30b from the power supply circuit 38d.

The power supply system 26 includes two connection devices 66. The two connection devices 66 are a connection device 66a and a connection device 66b. The connection devices 66 each include two contactors 68. One contactor 68 is provided on the positive wire, and another contactor 68 is provided on the negative wire.

The connection device 66a can connect the power supply circuit 38a and the power supply circuit 38c via the connection circuit 56a. The connection device 66b can connect the power supply circuit 38b and the power supply circuit 38d via the connection circuit 56b.

The power supply system 26 includes four backflow prevention devices 70. The four backflow prevention devices 70 are a backflow prevention device 70a, a backflow prevention device 70b, a backflow prevention device 70c, and a backflow prevention device 70d. The backflow prevention device 70a is provided on the positive side of the power supply circuit 38a. The backflow prevention device 70b is provided on the positive side of the power supply circuit 38b. The backflow prevention device 70c is provided on the positive side of the power supply circuit 38c. The backflow prevention device 70d is provided on the positive side of the power supply circuit 38d. Each backflow prevention device 70 may be provided on the negative side of each power supply circuit 38.

The backflow prevention devices 70 each include a diode 72, and an insulated gate bipolar transistor (hereinafter, referred to as an IGBT) 74. Normally, the IGBT 74 is turned off. In the case where the IGBT 74 is OFF, the diode 72 prevents a backflow of the current in each of the power supply circuit 38a, the power supply circuit 38b, the power supply circuit 38c, and the power supply circuit 38d. In the case where the engine 32 is started, the IGBT 74 is turned on. In the case where the IGBT 74 is ON, by bypassing the diode 72, the backflow of the current is allowed in each of the power supply circuits 38. As a result, the electric power of the battery 54 can be supplied to the generator 34. Instead of the IGBT 74, an element such as a contactor or a relay may be used in each of the backflow prevention devices 70.

The power supply system 26 includes four second disconnection devices 78. The four second disconnection devices 78 are a second disconnection device 78a, a second disconnection device 78b, a second disconnection device 78c, and a second disconnection device 78d.

The second disconnection devices 78 each include three contactors 80 and one precharge resistor 82. One contactor 80 of the three contactors 80 is provided on the positive wire. Another contactor 80 of the three contactors 80 is provided on the negative wire. Still another contactor 80 of the three contactors 80 is provided in a precharge circuit that bypasses the contactor 80 provided on the negative wire. The precharge resistor 82 is provided in series with the contactor 80 in the precharge circuit.

The second disconnection device 78a can disconnect the power storage device 52a from the power supply circuit 38a. The second disconnection device 78b can disconnect the power storage device 52b from the power supply circuit 38b. The second disconnection device 78c can disconnect the power storage device 52c from the power supply circuit 38c. The second disconnection device 78d can disconnect the power storage device 52d from the power supply circuit 38d.

In the case where the power generation device 30a and the load module 40a are precharged with the DC power of the power storage device 52a, the second disconnection device 78a outputs the DC power from the power storage device 52a to the power supply circuit 38a via the precharge circuit. In the case where the power generation device 30a and the load module 40b are precharged with the DC power of the power storage device 52b, the second disconnection device 78b outputs the DC power from the power storage device 52b to the power supply circuit 38b via the precharge circuit. In the case where the power generation device 30b and the load module 40c are precharged with the DC power of the power storage device 52c, the second disconnection device 78c outputs the DC power from the power storage device 52c to the power supply circuit 38c via the precharge circuit. In the case where the power generation device 30b and the load module 40d are precharged with the DC power of the power storage device 52d, the second disconnection device 78d outputs the DC power from the power storage device 52d to the power supply circuit 38d via the precharge circuit.

The second disconnection devices 78 each include a current sensor 79. The current sensor 79 detects the current of electric power input to and output from each second disconnection device 78.

### Configuration of Control System

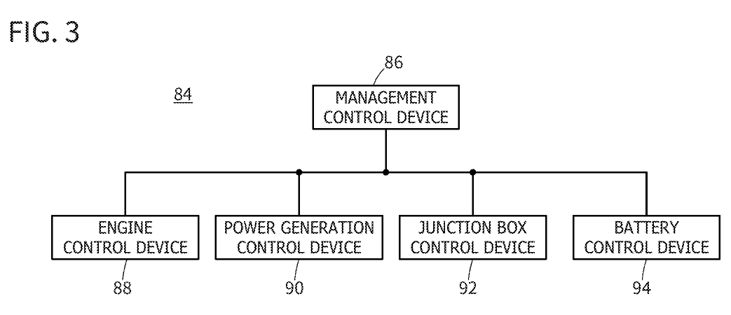

The flying object 10 includes a control system 84. FIG. 3 is a block diagram showing the control system 84 according to the embodiment.

The control system 84 includes a management control device 86, an engine control device 88, a power generation control device 90, a junction box control device 92, and a battery control device 94.

The management control device 86 is a control device that manages the engine control device 88, the power generation control device 90, the junction box control device 92, and the battery control device 94. The engine control device 88 controls the engines 32. The power generation control device 90 controls the PDUs 36. The junction box control device 92 controls the first disconnection devices 62, the connection devices 66, the IGBTs 74, and the like. The battery control device 94 monitors the state of charge (SOC) of the batteries 54, and controls the second disconnection devices 78 and the like.

### Configurations of Management Control Device and Engine Control Device

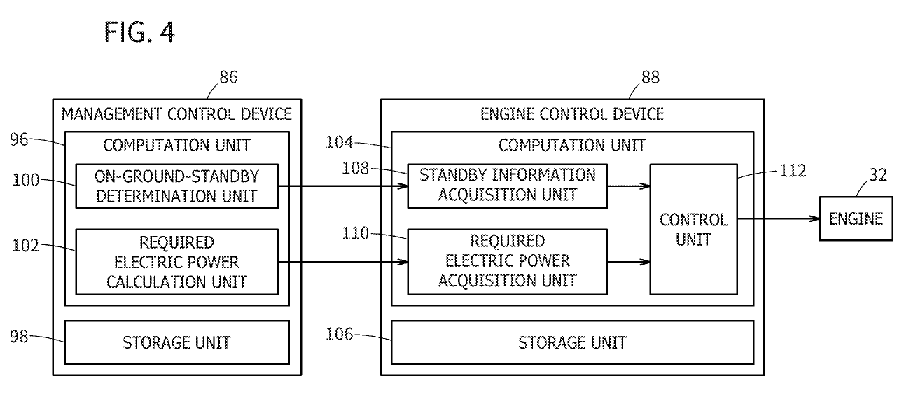

FIG. 4 is a block diagram showing a configuration of the management control device 86 and a configuration of the engine control device 88 according to the embodiment.

The management control device 86 includes a computation unit 96 and a storage unit 98. The computation unit 96 is, for example, a processor such as a central processing unit (CPU) or a graphics processing unit (GPU). The computation unit 96 includes an on-ground-standby determination unit 100 and a required electric power calculation unit 102. The on-ground-standby determination unit 100 and the required electric power calculation unit 102 are realized by the computation unit 96 executing a program stored in the storage unit 98. At least part of the on-ground-standby determination unit 100 and the required electric power calculation unit 102 may be realized by an integrated circuit such as an application specific integrated circuit (ASIC) or a field-programmable gate array (FPGA). At least part of the on-ground-standby determination unit 100 and the required electric power calculation unit 102 may be realized by an electronic circuit including a discrete device.

The storage unit 98 is a non-transitory computer-readable tangible storage medium. The storage unit 98 is constituted by a volatile memory (not shown) and a non-volatile memory (not shown). The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored in, for example, the non-volatile memory. At least part of the storage unit 98 may be included in the processor, the integrated circuit, or the like described above. At least part of the storage unit 98 may be mounted on a device connected to the flying object 10 via a network.

The on-ground-standby determination unit 100 determines whether or not the flying object 10 is on standby on the ground. The on-ground-standby determination unit 100 outputs, to the engine control device 88, standby information indicating whether or not the flying object 10 is on standby on the ground. It should be noted that, during standby on the ground, the VTOL electric motors 20 and the cruise electric motors 24 are stopped, but the auxiliary devices 25 are being driven.

The required electric power calculation unit 102 calculates required electric power. The required electric power indicates the sum of electric power required by the VTOL electric motors 20, the cruise electric motors 24, the batteries 54, and the auxiliary devices 25. In the case where the flying object 10 is on standby on the ground, the VTOL electric motors 20 and the cruise electric motors 24 are stopped, and therefore the required electric power includes only the electric power required by the auxiliary devices 25. The required electric power during standby on the ground may include electric power required by the batteries 54.

The engine control device 88 includes a computation unit 104 and a storage unit 106. The computation unit 104 is, for example, a processor such as a CPU or a GPU. The computation unit 104 includes a standby information acquisition unit 108, a required electric power acquisition unit 110, and a control unit 112. The standby information acquisition unit 108, the required electric power acquisition unit 110, and the control unit 112 are realized by the computation unit 104 executing a program stored in the storage unit 106. At least part of the standby information acquisition unit 108, the required electric power acquisition unit 110, and the control unit 112 may be realized by an integrated circuit such as an ASIC or an FPGA. At least part of the standby information acquisition unit 108, the required electric power acquisition unit 110, and the control unit 112 may be realized by an electronic circuit including a discrete device.

The storage unit 106 is a non-transitory computer-readable tangible storage medium. The storage unit 106 is constituted by a volatile memory (not shown) and a non-volatile memory (not shown). The volatile memory is, for example, a RAM or the like. The non-volatile memory is, for example, a ROM, a flash memory, or the like. Data and the like are stored in, for example, the volatile memory. Programs, tables, maps, and the like are stored in, for example, the non-volatile memory. At least part of the storage unit 106 may be included in the processor, the integrated circuit, or the like described above. At least part of the storage unit 106 may be mounted on a device connected to the flying object 10 via a network.

The standby information acquisition unit 108 acquires standby information from the management control device 86. The required electric power acquisition unit 110 acquires required electric power from the management control device 86. The control unit 112 controls the output power of each engine 32 based on the required electric power.

### Idling Control

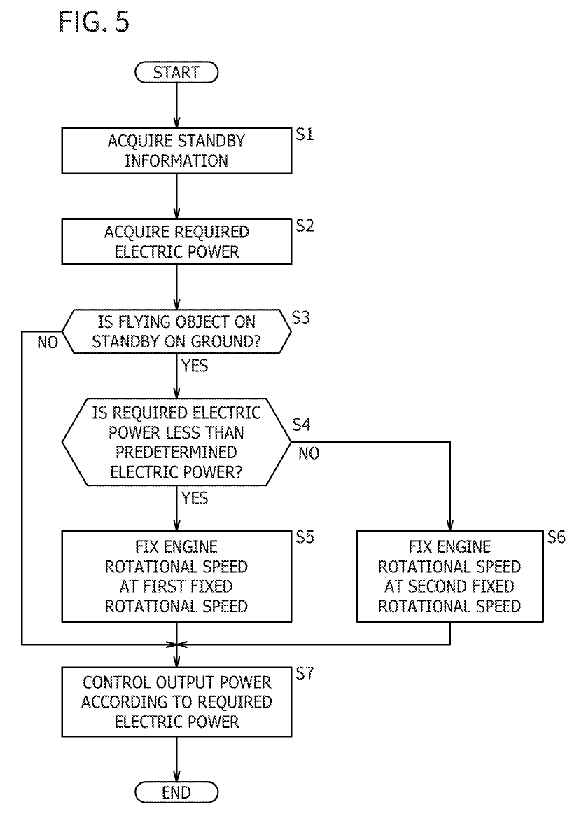

FIG. 5 is a flowchart of idling control executed by the engine control device 88 according to the embodiment. The idling control is repeatedly executed at a predetermined cycle.

In step S1, the standby information acquisition unit 108 acquires standby information, and the process proceeds to step S2.

In step S2, the required electric power acquisition unit 110 acquires required electric power, and the process proceeds to step S3.

In step S3, the control unit 112 determines whether or not the standby information indicates that the flying object 10 is on standby on the ground. In the case where it is indicated that the flying object 10 is on standby on the ground (step S3: YES), the process proceeds to step S4. In the case where it is not indicated that the flying object 10 is on standby on the ground (step S3: NO), the process proceeds to step S7.

In step S4, the control unit 112 determines whether or not the required electric power is less than predetermined electric power. In the case where the required electric power is less than the predetermined electric power, the process proceeds to step S5. In the case where the required electric power is equal to or greater than the predetermined electric power, the process proceeds to step S6. It should be noted that, since the process of step S4 is executed in the case where the flying object 10 is on standby on the ground, the required electric power does not include the electric power required by the VTOL electric motors 20 and the electric power required by the cruise electric motors 24, but includes the electric power required by the auxiliary devices 25.

In step S5, the control unit 112 controls the engine 32 to fix the engine rotational speed at a first fixed rotational speed. Thereafter, the process proceeds to step S7. The first fixed rotational speed is a rotational speed higher than an idling rotational speed described later.

In step S6, the control unit 112 controls the engine 32 to fix the engine rotational speed at a second fixed rotational speed. Thereafter, the process proceeds to step S7. The second fixed rotational speed is a rotational speed higher than the first fixed rotational speed.

In step S7, the control unit 112 controls the output power of the engine 32 according to the required electric power. Thereafter, the idling control is ended.

### Advantageous Effects

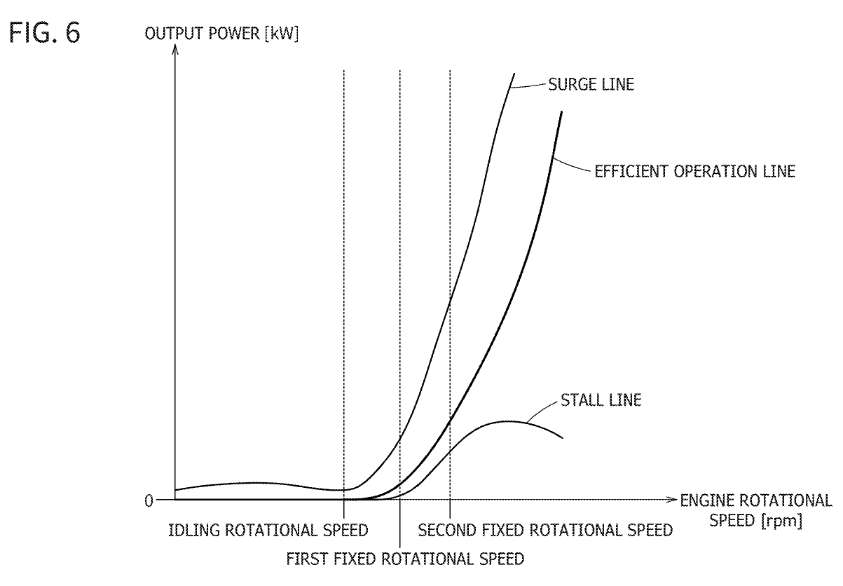

FIG. 6 is a graph showing a relationship between an engine rotational speed and output power on a surge line, a stall line, and an efficient operation line of the engine 32 according to the embodiment.

In the case where the operating point, which is a combination of the engine rotational speed and the output power of the engine 32, is located in a region above the surge line, a surge may occur in the engine 32. In the case where the operating point of the engine 32 is located in a region below the stall line, the engine 32 may stall.

By driving the engine 32 so that the operating point of the engine 32 is located on the efficient operation line, the engine 32 can be efficiently operated. The efficient operation line may not be a line indicating the most efficient operating point of the engine 32. The efficient operation line may be set so as to suppress surge, stall or the like of the engine 32 due to rotational fluctuation or the like of the engine 32. It should be noted that, in the case where the engine 32 is efficiently operated, the amount of fuel consumed by the engine 32 with respect to the output power of the engine 32 can be suppressed.

The idling rotational speed in FIG. 6 is a rotational speed at which the engine 32 can rotate in a self-sustaining manner in a no-load state. In the case where the engine rotational speed is the idling rotational speed, the output power on the efficient operation line is zero. Therefore, in the case where the engine 32 is in the no-load state, the engine 32 can be efficiently operated by setting the engine rotational speed to the idling rotational speed. However, in the case where the engine rotational speed is the idling rotational speed, the width between the surge line and the stall line is narrow, and therefore surge and stall of the engine 32 are likely to occur when the output power of the engine 32 fluctuates.

By setting the engine rotational speed to the first fixed rotational speed higher than the idling rotational speed, the width between the surge line and the stall line is increased, and therefore, the surge and the stall of the engine 32 are less likely to occur even when the output power of the engine 32 fluctuates. However, when the output power of the engine 32 is brought close to zero in a state where the engine rotational speed is the first fixed rotational speed, the operating point of the engine 32 is located below the stall line, and the engine 32 may stall. Further, in the case where the engine rotational speed is fixed, the efficiency of the engine 32 decreases as the output power decreases.

Therefore, according to the embodiment, in the case where the flying object 10 is on standby on the ground, the engine rotational speed is fixed at the first fixed rotational speed, and the generator 34 is driven by the engine 32. The electric power generated by the generator 34 is consumed by the auxiliary device 25.

As a result, it is possible to suppress a decrease in the efficiency of the engine 32 while suppressing surge and stall of the engine 32. Further, since the output power of the engine 32 is changed according to the required electric power of the auxiliary device 25 in a state where the engine rotational speed is fixed, the responsiveness of the output power of the engine 32 to the fluctuation of the required electric power of the auxiliary device 25 can be improved. Further, electric power consumed by the battery 54 during standby on the ground can be suppressed.

In the case where the required electric power of the auxiliary device 25 increases, the output power of the engine 32 may be insufficient for the required electric power of the auxiliary device 25 if the engine rotational speed is kept fixed at the first fixed rotational speed. In the case where the output power of the engine 32 is insufficient for the required electric power of the auxiliary device 25, the insufficient power is compensated by the electric power of the battery 54.

In the embodiment, in the case where the flying object 10 is on standby on the ground and the required electric power of the auxiliary device 25 is equal to or greater than the predetermined electric power, the engine rotational speed is fixed at the second fixed rotational speed, and the generator 34 is driven by the engine 32.

As a result, even in the case where the required electric power of the auxiliary device 25 increases, the required electric power of the auxiliary device 25 can be covered by the electric power generated by the generator 34 without taking out the electric power of the battery 54.

The following supplementary notes are further disclosed in relation to the above-described embodiment.

### Supplementary Note 1

The engine control device (88) of the present disclosure is an engine control device for the flying object (10) that includes the engine (32), the generator (34) configured to be driven by the engine and generate electric power, the power storage device (52) configured to store electric power, and the electric device (25) configured to operate using the electric power generated by the generator or the electric power stored in the power storage device, the engine control device including: the standby information acquisition unit (108) configured to acquire standby information indicating whether or not the flying object is on standby on the ground; the required electric power acquisition unit (110) configured to acquire required electric power of the electric device; and the control unit (112) configured to control the engine, wherein the control unit controls output power of the engine based on the required electric power acquired by the required electric power acquisition unit, and in the case where the standby information indicates that the flying object is on standby on the ground, the control unit fixes the engine rotational speed that is the rotational speed of the engine, at the rotational speed determined in advance. According to this feature, it is possible to improve the responsiveness of the output power of the engine to the fluctuation of the required electric power while suppressing the decrease in the SOC of the battery while the flying object is standby on the ground.

### Supplementary Note 2

In the engine control device according to Supplementary Note 1, in the case where the standby information indicates that the flying object is on standby on the ground and the required electric power is less than the predetermined electric power, the control unit may fix the engine rotational speed at the first fixed rotational speed, and in the case where the standby information indicates that the flying object is on standby on the ground and the required electric power is equal to or greater than the predetermined electric power, the control unit may fix the engine rotational speed at the second fixed rotational speed higher than the first fixed rotational speed. According to this feature, even in the case where the required electric power is equal to or greater than the predetermined electric power, a decrease in the SOC of the battery can be suppressed.

### Supplementary Note 3

In the engine control device according to Supplementary Note 2, the first fixed rotational speed may be higher than the idling rotational speed that is a rotational speed at which the engine is rotatable in a self-sustaining manner in a no-load state. According to this feature, stall and surge of the engine can be suppressed.

### Supplementary Note 4

The flying object of the present disclosure includes the engine control device according to any one of Supplementary Notes 1 to 3.

### Supplementary Note 5

The engine control method of the present disclosure is an engine control method for the flying object that includes the engine, the generator configured to be driven by the engine and generate electric power, the power storage device configured to store electric power, and the electric device configured to operate using the electric power generated by the generator or the electric power stored in the power storage device, the engine control method including: causing the standby information acquisition unit to acquire standby information indicating whether or not the flying object is on standby on the ground; causing the required electric power acquisition unit to acquire required electric power of the electric device; and causing the control unit to control the engine, wherein the control unit controls output power of the engine based on the required electric power acquired by the required electric power acquisition unit, and in the case where the standby information indicates that the flying object is on standby on the ground, the control unit fixes the engine rotational speed that is the rotational speed of the engine, at the rotational speed determined in advance.

### Supplementary Note 6

In the engine control method according to Supplementary Note 5, in the case where the standby information indicates that the flying object is on standby on the ground and the required electric power is less than the predetermined electric power, the control unit may fix the engine rotational speed at the first fixed rotational speed, and in the case where the standby information indicates that the flying object is on standby on the ground and the required electric power is equal to or greater than the predetermined electric power, the control unit may fix the engine rotational speed at the second fixed rotational speed higher than the first fixed rotational speed.

### Supplementary Note 7

In the engine control method according to Supplementary Note 6, the first fixed rotational speed may be higher than the idling rotational speed that is a rotational speed at which the engine is rotatable in a self-sustaining manner in a no-load state.

### Supplementary Note 8

The program of the present disclosure causes a computer to execute the engine control method according to any one of Supplementary Notes 5 to 7.

### Supplementary Note 9

The non-transitory computer-readable storage medium of the present disclosure stores the program according to Supplementary Note 8.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. An engine control device for a flying object, the flying object including an engine, a generator configured to be driven by the engine and generate electric power, a power storage device configured to store electric power, and an electric device configured to operate using the electric power generated by the generator or the electric power stored in the power storage device,
the engine control device comprising one or more processors that execute computer-executable instructions stored in a memory,
wherein the one or more processors execute the computer-executable instructions to cause the engine control device to:
acquire standby information indicating whether or not the flying object is on standby on a ground;
acquire required electric power of the electric device;
control output power of the engine based on the required electric power that has been acquired; and
in a case where the standby information indicates that the flying object is on standby on the ground, fix an engine rotational speed that is a rotational speed of the engine, at a rotational speed determined in advance.

2. The engine control device according to claim 1, wherein
in a case where the standby information indicates that the flying object is on standby on the ground and the required electric power is less than predetermined electric power, the one or more processors cause the engine control device to fix the engine rotational speed at a first fixed rotational speed; and
in a case where the standby information indicates that the flying object is on standby on the ground and the required electric power is equal to or greater than the predetermined electric power, the one or more processors cause the engine control device to fix the engine rotational speed at a second fixed rotational speed higher than the first fixed rotational speed.

3. The engine control device according to claim 2, wherein
the first fixed rotational speed is higher than an idling rotational speed that is a rotational speed at which the engine is rotatable in a self-sustaining manner in a no-load state.

4. A flying object comprising the engine control device according to claim 1.

5. An engine control method for a flying object, the flying object including an engine, a generator configured to be driven by the engine and generate electric power, a power storage device configured to store electric power, and an electric device configured to operate using the electric power generated by the generator or the electric power stored in the power storage device,
the engine control method being executed by one or more processors and comprising:
acquiring standby information indicating whether or not the flying object is on standby on a ground;
acquiring required electric power of the electric device;
controlling output power of the engine based on the required electric power that has been acquired; and
in a case where the standby information indicates that the flying object is on standby on the ground, fixing an engine rotational speed that is a rotational speed of the engine, at a rotational speed determined in advance.

6. The engine control method according to claim 5, wherein
in a case where the standby information indicates that the flying object is on standby on the ground and the required electric power is less than predetermined electric power, the engine rotational speed is fixed at a first fixed rotational speed, and
in a case where the standby information indicates that the flying object is on standby on the ground and the required electric power is equal to or greater than the predetermined electric power, the engine rotational speed is fixed at a second fixed rotational speed higher than the first fixed rotational speed.

7. The engine control method according to claim 6, wherein
the first fixed rotational speed is higher than an idling rotational speed that is a rotational speed at which the engine is rotatable in a self-sustaining manner in a no-load state.

8. A non-transitory computer-readable storage medium configured to store a program for causing a computer to execute the engine control method according to claim 5.
